(19) United States
(12) Patent Application Publication
(10) Pub. No.: US 2025/0007549 A1
(43) Pub. Date: Jan. 2, 2025

(54) Electronic Device with Non-Coherent Receiver

(71) Applicant: Apple Inc., Cupertino, CA (US)

(72) Inventor: Ramin Khayatzadeh, Munich (DE)

(21) Appl. No.: 18/674,440

(22) Filed: May 24, 2024

Related U.S. Application Data
(60) Provisional application No. 63/510,575, filed on Jun. 27, 2023.

(51) Int. Cl. H04B 1/16; H04B 1/00

(52) U.S. Cl. CPC H04B 1/16; H04B 1/005

(57) ABSTRACT

An electronic device may include wireless circuitry with a non-coherent receiver and a phased antenna array that receives a radio-frequency signal having a sub-THz carrier and one or two sidebands separated from the carrier by an intermediate frequency and carrying wireless data. The receiver may include respective receive paths coupled to each antenna in the phased antenna array, a signal combiner coupled to each of the receive paths, and a demodulator. Each receive path may have a respective passive square law envelope detector and a respective phase shifter. The envelope detectors may generate intermediate frequency signals at the intermediate frequency based on the radio-frequency signals. The phase shifters may phase shift the intermediate frequency signals to generate a phase-aligned intermediate frequency signal. The demodulator may recover the wireless data by demodulating the phase-aligned intermediate frequency signal.

This application claims the benefit of U.S. Provisional Patent Application No. 63/510,575, filed Jun. 27, 2023, which is hereby incorporated by reference herein in its entirety.

### FIELD

This disclosure relates generally to electronic devices, including electronic devices with wireless circuitry.

### BACKGROUND

Electronic devices can be provided with wireless capabilities. An electronic device with wireless capabilities has wireless circuitry that includes one or more antennas. The wireless circuitry is used to perform communications using radio-frequency signals conveyed by the antennas.

As software applications on electronic devices become more data-intensive over time, demand has grown for electronic devices that support wireless communications at higher data rates. In practice, the maximum data rate supported by an electronic device is limited by the frequency of the radio-frequency signals. However, as frequency increases, it can become more difficult to perform satisfactory wireless communications. For example, the wireless circuitry can consume an excessive amount of power and can be subject to excessive levels of noise.

### SUMMARY

An electronic device may include wireless circuitry. The wireless circuitry may include a non-coherent receiver. The non-coherent receiver may receive a radio-frequency signal using a phased antenna array. The radio-frequency signal may be a sub-THz signal having a sub-THz carrier and one or two sidebands. The sideband(s) may be separated from the carrier by an intermediate frequency. The sideband(s) may be modulated with wireless data.

The non-coherent receiver may include respective receive paths coupled to each antenna in the phased antenna array. The non-coherent receiver may include a signal combiner coupled to each of the receive paths and may include a demodulator coupled to the signal combiner. Each receive path may have a respective passive square law envelope detector and a respective phase shifter. The envelope detectors may generate intermediate frequency signals at the intermediate frequency based on the radio-frequency signals. The phase shifters may apply a set of phase shifts to the intermediate frequency signals to generate a phase-aligned intermediate frequency signal combined at the signal combiner. The demodulator may recover the wireless data by demodulating the phase-aligned intermediate frequency signal. In this way, the non-coherent receiver may receive the wireless data without use of a local oscillator, which serves to minimize phase noise, frequency drift, and power consumption in the device.

An aspect of the disclosure provides an electronic device. The electronic device can include a demodulator. The electronic device can include a phased antenna array configured to receive a radio-frequency signal at a first frequency greater than or equal to 100 GHz, the phased antenna array including a first antenna coupled to the demodulator over a first receive path. The electronic device can include a first envelope detector disposed on the first receive path and configured to downconvert the radio-frequency signal to a second frequency. The electronic device can include a first phase shifter disposed on the first receive path between the first envelope detector and the demodulator.

An aspect of the disclosure provides wireless circuitry. The wireless circuitry can include a first receive path configured to receive a radio-frequency signal having a first phase. The wireless circuitry can include a second receive path configured to receive the radio-frequency signal with a second phase that is different from the first phase. The wireless circuitry can include a first envelope detector disposed on the first receive path and configured to generate a first intermediate frequency signal based on the radio-frequency signal having the first phase. The wireless circuitry can include a second envelope detector disposed on the second receive path and configured to generate a second intermediate frequency signal based on the radio-frequency signal with the second phase. The wireless circuitry can include a first phase shifter disposed on the first receive path and configured to apply a first phase shift to the first intermediate frequency signal. The wireless circuitry can include a second phase shifter disposed on the second receive path and configured to apply a second phase shift to the second intermediate frequency signal, the second phase shift being different from the first phase shift. The wireless circuitry can include a demodulator configured to receive a phase-aligned intermediate frequency signal from at least the first receive path and the second receive path, the demodulator being configured to recover wireless data from the phase-aligned intermediate frequency signal.

An aspect of the disclosure provides an electronic device. The electronic device can include a phased antenna array configured to receive a radio-frequency signal, the radio-frequency signal having a carrier at a first frequency and having a sideband that carries wireless data, the sideband being offset from the carrier by a second frequency. The electronic device can include a non-coherent receiver coupled to the phased antenna array. The non-coherent receiver can include envelope detectors coupled to respective antennas in the phased antenna array and configured to generate intermediate frequency signals at the second frequency based on the radio-frequency signal. The non-coherent receiver can include phase shifters configured to generate a phase-aligned signal at the second frequency based on a set of phase shifts applied to the intermediate frequency signals. The non-coherent receiver can include a demodulator configured to output the wireless data based on the phase-aligned signal.

### BRIEF DESCRIPTION OF THE DRAWINGS

FIG. 1 is a block diagram of an illustrative electronic device having wireless circuitry that conveys radio-frequency signals at frequencies greater than about 100 GHz in accordance with some embodiments.

FIG. 2 is a schematic diagram of an illustrative phased antenna array in accordance with some embodiments.

FIG. 3 is a circuit diagram of an illustrative non-coherent receiver that receives radio-frequency signals at frequencies greater than about 100 GHz using a phased antenna array in accordance with some embodiments.

FIG. 4 is a circuit diagram of an illustrative envelope detector in a non-coherent receiver in accordance with some embodiments.

FIG. 5 is a table showing how a non-coherent receiver of the type shown in FIG. 3 may optimize spectrum efficiency in accordance with some embodiments.

### DETAILED DESCRIPTION

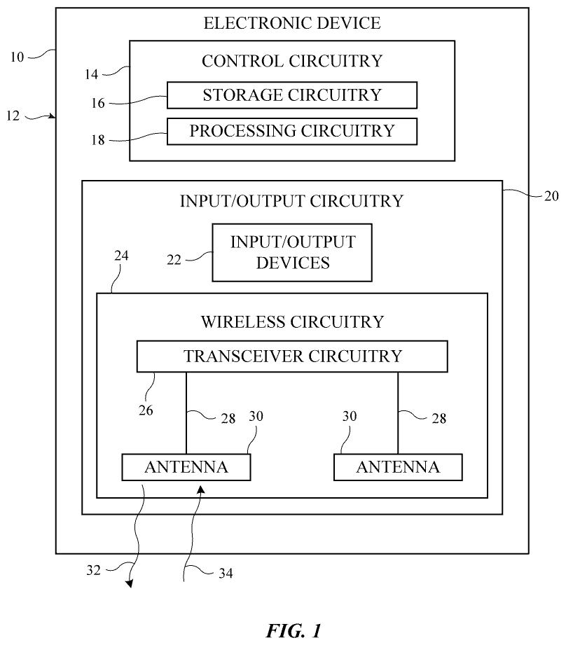

Electronic device 10 of FIG. 1 (sometimes referred to herein as electro-optical device 10) may be a computing device such as a laptop computer, a desktop computer, a computer monitor containing an embedded computer, a tablet computer, a cellular telephone, a media player, or other handheld or portable electronic device, a smaller device such as a wristwatch device, a pendant device, a headphone or earpiece device, a device embedded in eyeglasses, goggles, or other equipment worn on a user's head, or other wearable or miniature device, a television, a computer display that does not contain an embedded computer, a gaming device, a navigation device, an embedded system such as a system in which electronic equipment with a display is mounted in a kiosk or automobile, a wireless internet-connected voice-controlled speaker, a home entertainment device, a remote control device, a gaming controller, a peripheral user input device, a wireless base station or access point, equipment that implements the functionality of two or more of these devices, or other electronic equipment.

As shown in the functional block diagram of FIG. 1, device 10 may include components located on or within an electronic device housing such as housing 12. Housing 12, which may sometimes be referred to as a case, may be formed of plastic, glass, ceramics, fiber composites, metal (e.g., stainless steel, aluminum, metal alloys, etc.), other suitable materials, or a combination of these materials. In some situations, parts or all of housing 12 may be formed from dielectric or other low-conductivity material (e.g., glass, ceramic, plastic, sapphire, etc.). In other situations, housing 12 or at least some of the structures that make up housing 12 may be formed from metal elements.

Device 10 may include control circuitry 14. Control circuitry 14 may include storage such as storage circuitry 16. Storage circuitry 16 may include hard disk drive storage, nonvolatile memory (e.g., flash memory or other electrically-programmable-read-only memory configured to form a solid-state drive), volatile memory (e.g., static or dynamic random-access-memory), etc. Storage circuitry 16 may include storage that is integrated within device 10 and/or removable storage media.

Control circuitry 14 may include processing circuitry such as processing circuitry 18. Processing circuitry 18 may be used to control the operation of device 10. Processing circuitry 18 may include on one or more processors such as microprocessors, microcontrollers, digital signal processors, host processors, baseband processor integrated circuits, application specific integrated circuits, central processing units (CPUs), graphics processing units (GPUs), etc. Control circuitry 14 may be configured to perform operations in device 10 using hardware (e.g., dedicated hardware or circuitry), firmware, and/or software. Software code for performing operations in device 10 may be stored on storage circuitry 16 (e.g., storage circuitry 16 may include non-transitory (tangible) computer readable storage media that stores the software code). The software code may sometimes be referred to as program instructions, software, data, instructions, or code. Software code stored on storage circuitry 16 may be executed by processing circuitry 18.

Control circuitry 14 may be used to run software on device 10 such as satellite navigation applications, internet browsing applications, voice-over-internet-protocol (VOIP) telephone call applications, email applications, media playback applications, operating system functions, etc. To support interactions with external equipment, control circuitry 14 may be used in implementing communications protocols. Communications protocols that may be implemented using control circuitry 14 include internet protocols, wireless local area network (WLAN) protocols (e.g., IEEE 802.11 protocols—sometimes referred to as Wi-Fi®), protocols for other short-range wireless communications links such as the Bluetooth® protocol or other wireless personal area network (WPAN) protocols, IEEE 802.11ad protocols (e.g., ultra-wideband protocols), cellular telephone protocols (e.g., 3G protocols, 4G (LTE) protocols, 3GPP Fifth Generation (5G) New Radio (NR) protocols, Sixth Generation (6G) protocols, sub-THz protocols, THz protocols, etc.), antenna diversity protocols, satellite navigation system protocols (e.g., global positioning system (GPS) protocols, global navigation satellite system (GLONASS) protocols, etc.), antenna-based spatial ranging protocols, optical communications protocols, or any other desired communications protocols. Each communications protocol may be associated with a corresponding radio access technology (RAT) that specifies the physical connection methodology used in implementing the protocol.

Device 10 may include input-output circuitry 20. Input-output circuitry 20 may include input-output devices 22. Input-output devices 22 may be used to allow data to be supplied to device 10 and to allow data to be provided from device 10 to external devices. Input-output devices 22 may include user interface devices, data port devices, and other input-output components. For example, input-output devices 22 may include touch sensors, displays (e.g., touch-sensitive and/or force-sensitive displays), light-emitting components such as displays without touch sensor capabilities, buttons (mechanical, capacitive, optical, etc.), scrolling wheels, touch pads, key pads, keyboards, microphones, cameras, buttons, speakers, status indicators, audio jacks and other audio port components, digital data port devices, motion sensors (accelerometers, gyroscopes, and/or compasses that detect motion), capacitance sensors, proximity sensors, magnetic sensors, force sensors (e.g., force sensors coupled to a display to detect pressure applied to the display), temperature sensors, etc. In some configurations, keyboards, headphones, displays, pointing devices such as trackpads, mice, and joysticks, and other input-output devices may be coupled to device 10 using wired or wireless connections (e.g., some of input-output devices 22 may be peripherals that are coupled to a main processing unit or other portion of device 10 via a wired or wireless link).

Input-output circuitry 20 may include wireless circuitry 24 to support wireless communications. Wireless circuitry 24 (sometimes referred to herein as wireless communications circuitry 24) may include one or more antennas 30. Wireless circuitry 24 may also include transceiver circuitry 26. Transceiver circuitry 26 may include transmitter circuitry (e.g., one or more radio-frequency transmitters), receiver circuitry (e.g., one or more radio-frequency receivers), modulator circuitry, demodulator circuitry (e.g., one or more modems), radio-frequency circuitry, one or more radios, intermediate frequency circuitry, optical transmitter circuitry, optical receiver circuitry, optical light sources, other optical components, baseband circuitry (e.g., one or more baseband processors), amplifier circuitry, clocking circuitry such as one or more local oscillators and/or phase-locked loops, memory, one or more registers, filter circuitry, switching circuitry, analog-to-digital converter (ADC) circuitry, digital-to-analog converter (DAC) circuitry, radio-frequency transmission lines, optical fibers, and/or any other circuitry for transmitting and/or receiving wireless signals using antennas 30. The components of transceiver circuitry 26 may be implemented on one integrated circuit, chip, system-on-chip (SOC), die, printed circuit board, substrate, or package, or the components of transceiver circuitry 26 may be distributed across two or more integrated circuits, chips, SOCs, printed circuit boards, substrates, and/or packages.

The example of FIG. 1 is illustrative and non-limiting. While control circuitry 14 is shown separately from wireless circuitry 24 in the example of FIG. 1 for the sake of clarity, wireless circuitry 24 may include processing circuitry (e.g., one or more processors) that forms a part of processing circuitry 18 and/or storage circuitry that forms a part of storage circuitry 16 of control circuitry 14 (e.g., portions of control circuitry 14 may be implemented on wireless circuitry 24). As an example, control circuitry 14 may include baseband circuitry (e.g., one or more baseband processors), digital control circuitry, analog control circuitry, and/or other control circuitry that forms part of wireless circuitry 24. The baseband circuitry may, for example, access a communication protocol stack on control circuitry 14 (e.g., storage circuitry 20) to: perform user plane functions at a PHY layer, MAC layer, RLC layer, PDCP layer, SDAP layer, and/or PDU layer, and/or to perform control plane functions at the PHY layer, MAC layer, RLC layer, PDCP layer, RRC, layer, and/or non-access stratum layer.

Transceiver circuitry 26 may be coupled to each antenna 30 in wireless circuitry 24 over a respective signal path 28 (sometimes referred to herein as radio-frequency signal path 28). Each signal path 28 may include one or more radio-frequency transmission lines (e.g., coaxial cables, microstrips, striplines, etc.), waveguides, optical fibers, and/or any other desired lines/paths for conveying wireless signals between transceiver circuitry 26 and antenna 30. Each signal path 28 may include one or more transmit paths for transmitting signals over the corresponding antenna 30 and/or may include one or more receive paths for receiving signals over the corresponding antenna 30. Circuitry may be disposed on the transmit path(s) for transmitting signals and may be disposed on the receive path(s) for receiving signals.

Antennas 30 may be formed using any desired antenna structures for conveying wireless signals. For example, antennas 30 may include antennas with resonating elements that are formed from dipole antenna structures, planar dipole antenna structures (e.g., bowtie antenna structures), slot antenna structures, loop antenna structures, patch antenna structures, inverted-F antenna structures, planar inverted-F antenna structures, helical antenna structures, monopole antennas, dipoles, hybrids of these designs, etc. Filter circuitry, switching circuitry, impedance matching circuitry, and/or other antenna tuning components may be adjusted to adjust the frequency response and wireless performance of antennas 30 over time.

If desired, two or more of antennas 30 may be integrated into a phased antenna array (sometimes referred to herein as a phased array antenna) in which each of the antennas conveys wireless signals with a respective phase and magnitude that is adjusted over time so the wireless signals constructively and destructively interfere to produce (form) a signal beam in a given pointing direction. The term “convey wireless signals” as used herein means the transmission and/or reception of the wireless signals (e.g., for performing unidirectional and/or bidirectional wireless communications with external wireless communications equipment). Antennas 30 may transmit the wireless signals by radiating the signals into free space (or to free space through intervening device structures such as a dielectric cover layer). Antennas 30 may additionally or alternatively receive the wireless signals from free space (e.g., through intervening devices structures such as a dielectric cover layer). The transmission and reception of wireless signals by antennas 30 each involve the excitation or resonance of antenna currents on an antenna resonating (radiating) element in the antenna by the wireless signals within the frequency band(s) of operation of the antenna.

Transceiver circuitry 26 may use antenna(s) 30 to transmit and/or receive wireless signals that convey wireless communications data between device 10 and external wireless communications equipment (e.g., one or more other devices such as device 10, a wireless access point or base station, etc.). The wireless communications data may be conveyed bidirectionally or unidirectionally. The wireless communications data may, for example, include data that has been encoded into corresponding data packets such as wireless data associated with a telephone call, streaming media content, internet browsing, wireless data associated with software applications running on device 10, email messages, etc.

Additionally or alternatively, wireless circuitry 24 may use antenna(s) 30 to perform wireless sensing operations. The sensing operations may allow device 10 to detect (e.g., sense or identify) the presence, location, orientation, and/or velocity (motion) of objects external to device 10. Control circuitry 14 may use the detected presence, location, orientation, and/or velocity of the external objects to perform any desired device operations. As examples, control circuitry 14 may use the detected presence, location, orientation, and/or velocity of the external objects to identify a corresponding user input for one or more software applications running on device 10 such as a gesture input performed by the user's hand(s) or other body parts or performed by an external stylus, gaming controller, head-mounted device, or other peripheral devices or accessories, to determine when one or more antennas 30 needs to be disabled or provided with a reduced maximum transmit power level (e.g., for satisfying regulatory limits on radio-frequency exposure), to determine how to steer (form) a radio-frequency signal beam produced by antennas 30 for wireless circuitry 24 (e.g., in scenarios where antennas 30 include a phased array of antennas 30), to map or model the environment around device 10 (e.g., to produce a software model of the room where device 10 is located for use by an augmented reality application, gaming application, map application, home design application, engineering application, etc.), to detect the presence of obstacles in the vicinity of (e.g., around) device 10 or in the direction of motion of the user of device 10, etc.

Wireless circuitry 24 may transmit and/or receive wireless signals within corresponding frequency bands of the electromagnetic spectrum (sometimes referred to herein as communications bands or simply as “bands”). The frequency bands handled by communications circuitry 26 may include wireless local area network (WLAN) frequency bands (e.g., Wi-Fi® (IEEE 802.11) or other WLAN communications bands) such as a 2.4 GHz WLAN band (e.g., from 2400 to 2480 MHz), a 5 GHz WLAN band (e.g., from 5180 to 5825 MHz), a Wi-Fi® 6E band (e.g., from 5925-7125 MHz), and/or other Wi-Fi® bands (e.g., from 1875-5160 MHz), wireless personal area network (WPAN) frequency bands such as the 2.4 GHz Bluetooth® band or other WPAN communications bands, cellular telephone frequency bands (e.g., bands from about 600 MHz to about 5 GHz, 3G bands, 4G LTE bands, 5G New Radio Frequency Range 1 (FR1) bands below 10 GHz, 5G New Radio Frequency Range 2 (FR2) bands between 20 and 60 GHz, etc.), other centimeter or millimeter wave frequency bands between 10-100 GHz, near-field communications frequency bands (e.g., at 13.56 MHz), satellite navigation frequency bands (e.g., a GPS band from 1565 to 1610 MHz, a Global Navigation Satellite System (GLONASS) band, a BeiDou Navigation Satellite System (BDS) band, etc.), ultra-wideband (UWB) frequency bands that operate under the IEEE 802.15.4 protocol and/or other ultra-wideband communications protocols, communications bands under the family of 3GPP wireless communications standards, communications bands under the IEEE 802.XX family of standards, and/or any other desired frequency bands of interest.

Over time, software applications on electronic devices such as device 10 have become more and more data intensive. Wireless circuitry on the electronic devices therefore needs to support data transfer at higher and higher data rates. In general, the data rates supported by the wireless circuitry are proportional to the frequency of the wireless signals conveyed by the wireless circuitry (e.g., higher frequencies can support higher data rates than lower frequencies). Wireless circuitry 24 may convey centimeter and millimeter wave signals to support relatively high data rates (e.g., because centimeter and millimeter wave signals are at relatively high frequencies between around 10 GHz and 100 GHz). However, the data rates supported by centimeter and millimeter wave signals may still be insufficient to meet all the data transfer needs of device 10. To support even higher data rates such as data rates up to 5-10 Gbps or higher, wireless circuitry 24 may convey wireless signals at frequencies greater than 100 GHz.

As shown in FIG. 1, wireless circuitry 24 may transmit wireless signals 32 and may receive wireless signals 34 at frequencies greater than around 100 GHz. Wireless signals 32 and 34 may sometimes be referred to herein as tremendously high frequency (THF) signals 32 and 34, sub-THz signals 32 and 34, THz signals 32 and 34, or sub-millimeter wave signals 32 and 34. THF signals 32 and 34 may be at sub-THz or THz frequencies such as frequencies between 100 GHz and 1 THz, between 100 GHz and 10 THz, between 100 GHz and 2 THz, between 200 GHz and 1 THz, between 300 GHz and 1 THz, between 300 GHz and 2 THz, between 300 GHz and 10 THz, between 100 GHz and 800 GHz, between 200 GHz and 1.5 THz, etc. (e.g., within a sub-THz, THz, THF, or sub-millimeter frequency band such as a 6G frequency band).

The high data rates supported by these frequencies may be leveraged by device 10 to perform cellular telephone voice and/or data communications (e.g., while supporting spatial multiplexing to provide further data bandwidth), to perform spatial ranging operations such as radar operations to detect the presence, location, and/or velocity of objects external to device 10, to perform automotive sensing (e.g., with enhanced security), to perform health/body monitoring on a user of device 10 or another person, to perform gas or chemical detection, to form a high data rate wireless connection between device 10 and another device or peripheral device (e.g., to form a high data rate connection between a display driver on device 10 and a display that displays ultra-high resolution video), to form a remote radio head (e.g., a flexible high data rate connection), to form a THF chip-to-chip connection within device 10 that supports high data rates (e.g., where one antenna 30 on a first chip in device 10 transmits THF signals 32 to another antenna 30 on a second chip in device 10), and/or to perform any other desired high data rate operations.

Wireless circuitry 30 may include one or more antennas 30 for conveying THF signals and/or may include one or more antennas 30 for conveying non-THF signals (e.g., at frequencies less than around 100 GHz). Implementations in which wireless circuitry 24 conveys THF signals are described herein as an example. However, in general, wireless circuitry 24 may convey non-THF signals in addition to or instead of THE signals. In implementations where wireless circuitry 24 conveys THF signals, different antennas 30 may be used to transmit THF signals 32 than are used to receive THF signals 34. However, space is at a premium within electronic devices such as device 10. Handling transmission of THF signals 32 and reception of THF signals 34 using different antennas 30 can consume an excessive amount of space and other resources within device 10 because two antennas 30 and signal paths 28 would be required to handle both transmission and reception. To minimize space and resource consumption within device 10, the same antenna 30 and signal path 28 may be used to both transmit THF signals 32 and to receive THE signals 34. If desired, multiple antennas 30 in wireless circuitry 24 may transmit THF signals 32 and may receive THE signals 34. The antennas may be integrated into a phased antenna array that transmits THF signals 32 and that receives THF signals 34 within a corresponding signal beam oriented in a selected beam pointing direction.

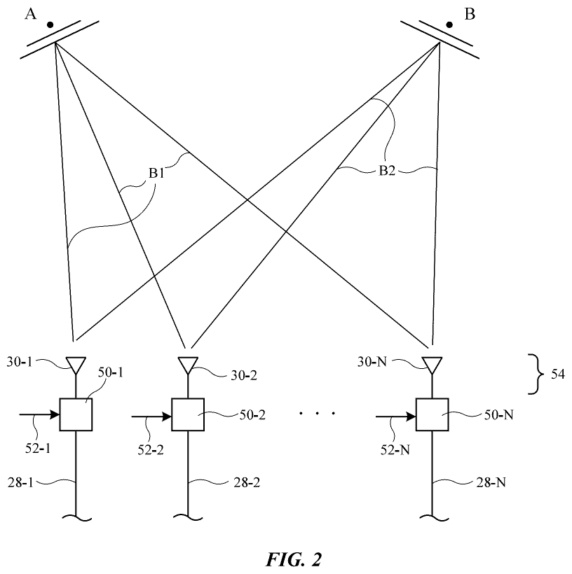

FIG. 2 shows how antennas 30 for handling THF signals 32 and/or 34 may be formed in a phased antenna array. As shown in FIG. 2, phased antenna array 54 (sometimes referred to herein as array 54, antenna array 54, or array 54 of antennas 30) may be coupled to signal paths 28. For example, a first antenna 30-1 in phased antenna array 54 may be coupled to a first signal path 28-1, a second antenna 30-2 in phased antenna array 54 may be coupled to a second signal path 28-2, an Nth antenna 30-N in phased antenna array 54 may be coupled to an Nth signal path 28-N, etc. While antennas 30 are described herein as forming a phased antenna array, the antennas 30 in phased antenna array 54 may sometimes also be referred to as collectively forming a single phased array antenna (e.g., where each antenna 30 is a resonating element or antenna element of the phased array antenna).

Antennas 30 in phased antenna array 54 may be arranged in any desired number of rows and columns or in any other desired pattern (e.g., the antennas need not be arranged in a grid pattern having rows and columns). During signal transmission operations, signal paths 28 may be used to supply signals (e.g., radio-frequency signals such as THE signals) from transceiver circuitry 26 (FIG. 1) to phased antenna array 54 for wireless transmission. During signal reception operations, signal paths 28 may be used to supply signals received at phased antenna array 54 (e.g., from external wireless equipment or transmitted signals that have been reflected off of external objects) to transceiver circuitry 26 (FIG. 1).

The use of multiple antennas 30 in phased antenna array 54 allows beam steering arrangements to be implemented by controlling the relative phases and magnitudes (amplitudes) of the radio-frequency signals conveyed by the antennas. In the example of FIG. 2, antennas 30 each have a corresponding radio-frequency phase and magnitude controller 50 (e.g., a first phase and magnitude controller 50-1 disposed on signal path 28-1 may control phase and magnitude for radio-frequency signals handled by antenna 30-1, a second phase and magnitude controller 50-2 disposed on signal path 28-2 may control phase and magnitude for radio-frequency signals handled by antenna 30-2, an Nth phase and magnitude controller 50-N disposed on signal path 28-N may control phase and magnitude for radio-frequency signals handled by antenna 30-N, etc.).

Phase and magnitude controllers 50 may each include circuitry for adjusting the phase of the radio-frequency signals on signal paths 28 (e.g., phase shifter circuits) and/or circuitry for adjusting the magnitude of the radio-frequency signals on signal paths 28 (e.g., power amplifier, low noise amplifier circuits, and/or signal attenuator circuits). Phase and magnitude controllers 50 may sometimes be referred to collectively herein as beam steering circuitry (e.g., beam steering circuitry that steers the beam of radio-frequency signals transmitted and/or received by phased antenna array 54).

Phase and magnitude controllers 50 may adjust the relative phases and/or magnitudes of the transmitted signals that are provided to each of the antennas in phased antenna array 54 and may adjust the relative phases and/or magnitudes of the received signals that are received by phased antenna array 54. Phase and magnitude controllers 50 may, if desired, include phase detection circuitry for detecting the phases of the received signals that are received by phased antenna array 54. The term “beam” or “signal beam” may be used herein to collectively refer to wireless signals that are transmitted and received by phased antenna array 54 in a particular direction. The signal beam may exhibit a peak gain that is oriented in a particular pointing direction at a corresponding pointing angle (e.g., based on constructive and destructive interference from the combination of signals from each antenna in the phased antenna array). The term “transmit beam” may sometimes be used herein to refer to radio-frequency signals that are transmitted in a particular direction whereas the term “receive beam” may sometimes be used herein to refer to radio-frequency signals that are received from a particular direction.

If, for example, phase and magnitude controllers 50 are adjusted to produce a first set of phases and/or magnitudes for transmitted radio-frequency signals, the transmitted signals will form a transmit beam as shown by beam B1 of FIG. 2 that is oriented in the direction of point A. If, however, phase and magnitude controllers 50 are adjusted to produce a second set of phases and/or magnitudes for the transmitted signals, the transmitted signals will form a transmit beam as shown by beam B2 that is oriented in the direction of point B. Similarly, if phase and magnitude controllers 50 are adjusted to produce the first set of phases and/or magnitudes, radio-frequency signals (e.g., radio-frequency signals in a receive beam) may be received from the direction of point A, as shown by beam B1. If phase and magnitude controllers 50 are adjusted to produce the second set of phases and/or magnitudes, radio-frequency signals may be received from the direction of point B, as shown by beam B2.

Each phase and magnitude controller 50 may be controlled to produce a desired phase and/or magnitude based on a corresponding control signal 52 received from control circuitry 14 of FIG. 1 (e.g., the phase and/or magnitude provided by phase and magnitude controller 50-1 may be controlled using control signal 52-1, the phase and/or magnitude provided by phase and magnitude controller 50-2 may be controlled using control signal 52-2, etc.). If desired, the control circuitry may actively adjust control signals 52 in real time to steer the transmit or receive beam in different desired directions over time. Phase and magnitude controllers 50 may provide information identifying the phase of received signals to control circuitry 14 if desired.

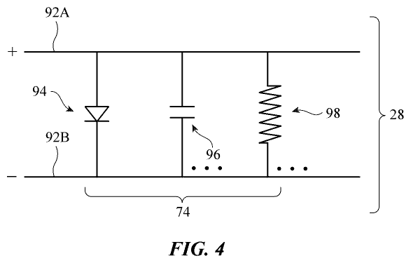

When performing wireless communications using radio-frequency signals at frequencies greater than or equal to around 100 GHz (e.g., THF signals), the radio-frequency signals are conveyed over a line of sight path between phased antenna array 54 and external communications equipment. If the external object is located at point A of FIG. 4, phase and magnitude controllers 50 may be adjusted to steer the signal beam towards point A (e.g., to steer the pointing direction of the signal beam towards point A). Phased antenna array 54 may transmit and receive radio-frequency signals in the direction of point A. Similarly, if the external communications equipment is located at point B, phase and magnitude controllers 50 may be adjusted to steer the signal beam towards point B (e.g., to steer the pointing direction of the signal beam towards point B). Phased antenna array 54 may transmit and receive radio-frequency signals in the direction of point B. In the example of FIG. 2, beam steering is shown as being performed over a single degree of freedom for the sake of simplicity (e.g., towards the left and right on the page of FIG. 2). However, in practice, the beam may be steered over two or more degrees of freedom (e.g., in three dimensions, into and out of the page and to the left and right on the page of FIG. 2). Phased antenna array 54 may have a corresponding field of view over which beam steering can be performed (e.g., in a hemisphere or a segment of a hemisphere over the phased antenna array). If desired, device 10 may include multiple phased antenna arrays that each face a different direction to provide coverage from multiple sides of the device.

Transceiver circuitry 26 (FIG. 1) may include one or more receivers that receive THF signals 34 using a phased antenna array 54 of antennas 30. In some configurations, the receiver may be a coherent receiver. The coherent receiver receives THF signals 34 based on a local oscillator (LO) signal generated by clocking circuitry on transceiver 26. The coherent receiver includes a mixer that downconverts the received THE signals 34 from a sub-THz frequency to a lower frequency by mixing the received THE signals with an LO signal at the sub-THz frequency. However, local oscillators at relatively high frequencies such as sub-THz frequencies can suffer from excessive phase noise and frequency drift.

The transceiver can attempt to reduce phase noise using a phase-locked loop (PLL) that is based on a lower reference frequency. The PLL may, for example, include an optical PLL (OPLL) (sometimes referred to herein as an electro-optical PLL (EOPLL)) for generating the sub-THz LO signal. However, while optical PLLs offer improved phase noise and frequency stability, optical PLLs suffer from optical amplitude noise such as relative intensity noise (RIN) (e.g., from one or more lasers in the optical PLL) and shot noise (e.g., due to the arrival of photons at a photodiode in the optical PLL at random times). In addition, optical PLLs can consume an excessive amount of power in device 10, particularly when the receiver is coupled to multiple antennas such as the antennas 30 in phased antenna array 54. As an example, the optical PLL may consume as much as 300-500 mW of power when phased antenna array 54 includes a 4-by-4 set of antennas 30.

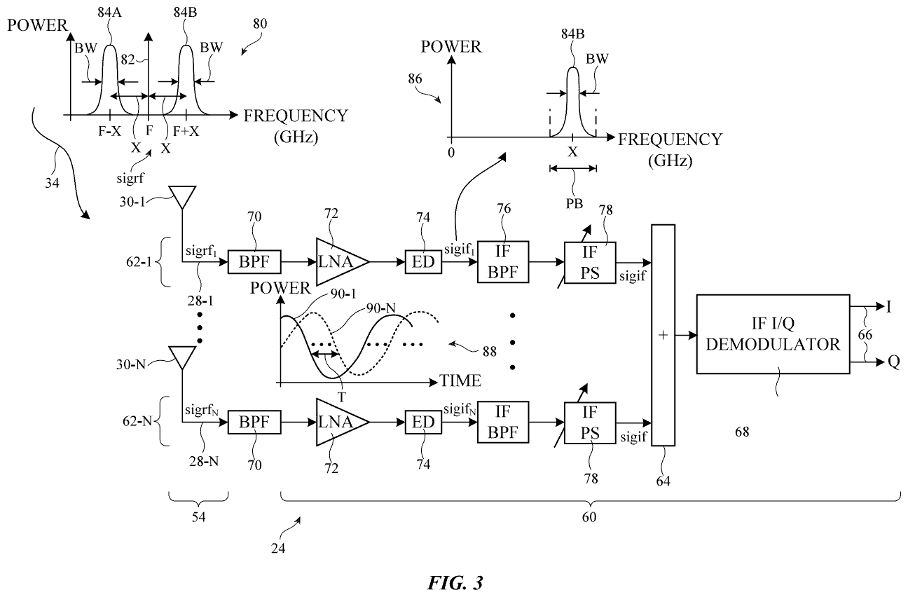

To mitigate these issues and to allow device 10 to receive THF signals 34 with satisfactory levels of signal quality while minimizing power consumption and noise, the receiver used to receive THE signals 34 may be a non-coherent receiver. FIG. 3 is a circuit diagram showing how wireless circuitry 24 may include a non-coherent receiver for receiving THF signals 34 over phased antenna array 54.

As shown in FIG. 3, wireless circuitry 24 may include one or more non-coherent receivers such as non-coherent receiver 60. Each of the N antennas 30 in phased antenna array 54 may be coupled to non-coherent receiver 60 over a corresponding signal path 28 (e.g., antenna 30-1 may be coupled to non-coherent receiver 60 over signal path 28-1, antenna 30-N may be coupled to non-coherent receiver 60 over signal path 28-N, etc.). Each signal path 28 may have circuitry disposed thereon that forms a respective receive path 62 (e.g., signal path 28-1 may include a receive path 62-1 coupled to antenna 30-1, signal path 28-N may include a receive path 62-N coupled to antenna 30-N, etc.). Receive paths 62 may sometimes also be referred to herein as receive chains 62. Some or all of the components of each receive path 62 may be included as a part of non-coherent receiver 60 and/or some or all of the components of each receive path 62 may be external to non-coherent receiver 60 (e.g., coupled between non-coherent receiver 60 and antennas 30, disposed on a radio-frequency front end module between antennas 30 and non-coherent receiver 60, etc.).

The example of FIG. 3 is illustrative and non-limiting. While each of the N receive paths 62 are shown in FIG. 3 as including circuitry that forms a part of a single non-coherent receiver 60, wireless circuitry 24 may equivalently be referred to as including a set of N different non-coherent receivers 60, each of which is coupled to a different respective antenna 30 (e.g., where each non-coherent receiver includes circuitry from a different respective receive path 62 and/or is coupled to a different respective receive path 62).

FIG. 3 illustrates only the reception of THE signals 34 using phased antenna array 54 for the sake of clarity. If desired, wireless circuitry 24 of FIG. 3 may also include one or more transmitters and/or transmit paths/chains (not shown) coupled to phased antenna array 54 for transmitting THF signals 32 (FIG. 1). In other words, phased antenna array 54 may, if desired, both transmit THF signals 32 and receive THF signals 34. Alternatively, phased antenna array 54 may be dedicated to receiving THF signals 34 without also transmitting THF signals 32 (e.g., phased antenna array 54 may be coupled to non-coherent receiver 60 without being coupled to a transmitter).

As shown in FIG. 3, non-coherent receiver 60 may include a signal combiner (adder) 64 and demodulation circuitry such as in-phase (I) and quadrature-phase (Q) (I/Q) demodulator 66 (sometimes referred to herein as signal demodulator 66). Signal combiner 64 may have N inputs. Each of the N inputs of signal combiner 64 may be coupled to the output of a different respective receive path 62. Signal combiner 64 may have an output coupled to the input of I/Q demodulator 66. I/Q demodulator 66 may have an output 68 coupled to baseband circuitry in wireless circuitry 24. The output 68 of I/Q demodulator 66 may include, for example, an I/Q data path (e.g., a baseband I/Q data path) having a first signal line that carries in-phase (I) data and a second signal line that carries the corresponding quadrature-phase (Q) data.

Each receive path 62 in wireless circuitry 24 may include a first filter such as bandpass filter (BPF) 70, an amplifier such as low noise amplifier (LNA) 72, envelope detection circuitry such as envelope detector (ED) 74, a second filter such as BPF 76, and a phase shifter such as phase shifter (PS) 78 (e.g., coupled in series on the signal path 28 between the corresponding antenna 30 and signal combiner 64). The input of BPF 70 may be coupled to the corresponding antenna 30. The output of BPF 70 may be coupled to the input of LNA 72. The output of LNA 72 may be coupled to the input of ED 74. The output of ED 74 may be coupled to the input of BPF 76. The output of BPF 76 may be coupled to the input of PS 78. The output of PS 78 may be coupled to the corresponding input of signal combiner 64. If desired, additional components (not shown) may be disposed on each receive path 62 for receiving signals using phased antenna array 54.

During signal reception, THF signals 34 may be transmitted by external communications equipment (e.g., another device such as device 10, a wireless base station, a wireless access point, etc.). THF signals 34 may be incident upon phased antenna array 54 from a particular incident angle or direction. As incident at phased antenna array 54, THF signals 34 may sometimes be referred to herein as radio-frequency signal sigrf.

Plot 80 of FIG. 3 illustrates radio-frequency signal sigrf in the frequency domain. As shown by plot 80, the external communications equipment may generate radio-frequency signal sigrf by modulating (e.g., amplitude modulating, phase modulating, etc.) wireless data onto a carrier 82 at carrier frequency F. Carrier frequency F may be a sub-THz frequency greater than or equal to around 100 GHz (e.g., 300 GHz). Modulating carrier 82 with wireless data may produce one or two sidebands 84 that are each separated from carrier frequency F by an intermediate frequency X. Intermediate frequency X is a radio frequency that is less than carrier frequency F and greater than a baseband frequency.

In the example shown in plot 80, the external communications equipment generates radio-frequency signal sigrf as a dual sideband (DSB) signal that includes both a first sideband 84A at frequency F−X and a second sideband 84B at frequency F+X. In other implementations, the external communications equipment may generate radio-frequency signal sigrf as a single sideband (SSB) signal that includes only sideband 84A or only sideband 84B. SSB modulation may be sufficient for device 10 to detect the received signal and may serve to increase spectral efficiency but may reduce intermediate frequency signal power, for example.

Sideband(s) 84 may carry the wireless data that the external communications equipment has modulated onto carrier 82. The external communications equipment may modulate the wireless data onto carrier 82 using any desired modulation scheme and/or any desired modulation order. As examples, the external communications equipment may modulate the wireless data using quadrature amplitude modulation (QAM) (e.g., 16-QAM, 64-QAM, etc.), amplitude-shift keying (ASK), phase-shift keying (PSK) (e.g., binary phase-shift keying (BPSK), quadrature phase-shift keying (QPSK), etc.), frequency-shift keying (FSK), orthogonal frequency division multiplexing (OFDM), or any other desired modulation scheme. As such, each sideband 84 exhibits a corresponding bandwidth BW. In implementations where radio-frequency signal sigrf is a DSB signal, sidebands 84A and 84B carry copies of the same wireless data.

The antennas 30 in phased antenna array 54 may receive the radio-frequency signal sigrf incident upon phased antenna array 54. Radio-frequency signal sigrf may be incident upon different antennas 30 in phased antenna array 54 at slightly different times due to the differences in path length to reach each of the antennas 30 in phased antenna array 54 (e.g., as given by the incident angle of THE signals 34 and the antenna spacing/geometry in phased antenna array 54). These path length differences may cause each antenna 30 to pass a different respective radio-frequency signal sigrfᵢ onto the corresponding signal path 28 (e.g., antenna 30-1 may pass radio-frequency signal sigrf₁ onto signal path 28-1, antenna 30-N may pass radio-frequency signal sigrf_{N} onto signal path 28-N, etc.).

Each radio-frequency signal sigrfᵢ is a version of radio-frequency signal sigrf that has been received by the corresponding antenna 30 at a slightly different time. As such, each radio-frequency signal sigrfᵢ includes the same wireless data. Plot 88 of FIG. 3 shows the time relationship between each of the radio-frequency signals sigrfᵢ received across phased antenna array 54. Curve 90-1 of plot 88 plots the radio-frequency signal sigrfᵢ received by antenna 30-1 (as a function of time). Curve 90-N of plot 88 plots the radio-frequency signal sigrf_{N} received by antenna 30-N.

As shown by curves 90-1 and 90-N, the radio-frequency signal sigrf_{N} received by antenna 30-N is delayed by time T with respect to the radio-frequency signal sigrf₁. This is because, given the incident angle of THE signals 34 and the geometry of phased antenna array 54, radio-frequency signal sigrf needs to traverse a greater path length to reach antenna 30-N than antenna 30-N, causing radio-frequency signal sigrf to reach antenna 30-N at a time T after reaching antenna 30-1. Similarly, radio-frequency signal sigrf is received by the other antennas between antennas 30-1 and 30-N at different respective times within time T (e.g., between curves 90-1 and 90-N of plot 88). This delay in receipt of radio-frequency signal sigrf by a time less than or equal to time T at different antennas 30 across phased antenna array 54 is equivalent to the receipt of radio-frequency signal sigrf with different phases at different antenna 30 across phased antenna array 54. Put differently, each radio-frequency signal sigrfᵢ received by phased antenna array 54 is phase shifted with respect to the other radio-frequency signals sigrfᵢ received by phased antenna array 54 (e.g., curve 90-N is phase shifted with respect to curve 90-1 by a phase shift corresponding to time T, etc.).

In this way, the radio-frequency signals sigrfᵢ received across phased antenna array 54 are non-coherent with respect to each other. Put differently, non-coherent receiver 60 may receive N non-coherent copies of radio-frequency signal sigrf from the N antennas 30 in phased antenna array 54 (e.g., receive paths 62 may receive and process N non-coherent copies of radio-frequency signal sigrf).

Within each receive path 62, BPF 70 may receive the corresponding radio-frequency signal sigrfᵢ. BPF 70 may have a passband that overlaps carrier 82 and one or both sidebands 84. As such, BPF 70 may pass carrier 82 and sideband(s) 84 from the corresponding radio-frequency signal sigrfᵢ to LNA 72. At the same time, BPF 70 may, for example, remove any potential interference produced by image frequencies and/or other out-of-band interference frequencies from the corresponding radio-frequency signal sigrfᵢ.

LNA 72 and PS 78 may collectively form part of the phase and magnitude controller 50 (FIG. 2) for the corresponding antenna 30. LNA 72 may amplify the radio-frequency signal sigrfᵢ received from BPF 70. LNA 72 may pass the amplified radio-frequency signal sigrfᵢ to ED 74.

In some implementations that are described herein as an example, ED 74 may be a square law envelope detector. In these implementations, ED 74 mixes the carrier of an input signal with a sideband of the input signal to recover (e.g., generate, produce, output, etc.) an output signal at a frequency given by the difference (offset) in frequency between the carrier and the sideband. In other words, ED 74 may receive the input signal and may output the magnitude of the input signal squared (e.g., ED 74 may output an envelope of the input signal).

As such, ED 74 may receive the filtered and amplified radio-frequency signal sigrfᵢ from LNA 72 and may output (e.g., generate, produce, compute, calculate, compute, etc.) a corresponding intermediate frequency signal sigifᵢ based on radio-frequency signal sigrfᵢ (e.g., the ED 74 in receive path 62-1 may generate intermediate frequency signal sigif₁, the ED 74 in receive path 62-N may generate intermediate frequency signal sigif_{N}, etc.). Intermediate frequency signal sigifᵢ may, for example, represent an envelope of radio-frequency signal sigrfᵢ generated by squaring radio-frequency signal sigrfᵢ.

ED 74 may have an output bandwidth equal to the bandwidth BW of the sideband(s) 84 in radio-frequency signal sigrf. Intermediate frequency signal sigifᵢ may, for example, represent the separation between carrier 82 and one of sidebands 84. The frequency of intermediate frequency signal sigif is therefore equal to intermediate frequency X, which is given by the offset (difference) between carrier frequency F and the frequency of sideband(s) 84 in radio-frequency signal sigrfᵢ (e.g., as shown in plot 80). Put differently, ED 74 may downconvert radio-frequency signal sigrfᵢ to intermediate frequency X (as intermediate frequency signal sigifᵢ). Intermediate frequency X may be, for example, 15 GHz, 10 GHz, 5 GHz, 1-15 GHz, 1-20 GHz, 1-30 GHz, less than 10 GHz, less than 20 GHz, less than 30 GHz, greater than 1 GHz, greater than 5 GHz, greater than 10 GHz, 1-100 GHz, tens of GHz, 10-80 GHz, 5-60 GHz, or other frequencies depending on the bandwidth of communication.

ED 74 may pass intermediate frequency signal sigifᵢ to BPF 76. BPF 76 may be an intermediate frequency (IF) BPF. BPF 76 may filter intermediate frequency signal sigifᵢ to produce (e.g., generate, output, etc.) a filtered intermediate frequency signal sigifᵢ. Plot 86 of FIG. 3 shows intermediate frequency signal sigifᵢ as output by ED 74. As shown by plot 86, intermediate frequency signal sigifᵢ includes on one of sidebands 84 (e.g., sideband 84B) at intermediate frequency X relative to DC (e.g., 0 GHz). Since sideband 84B has wireless data modulated thereon, sideband 84B has bandwidth BW.

BPF 76 may have a passband PB that overlaps sideband 84B (e.g., centered at intermediate frequency X). Passband PB may, for example, having a bandwidth greater than or equal to the bandwidth BW of sideband 84B (e.g., the output bandwidth of ED 74). As such, BPF 74 may pass only sideband 84B of intermediate frequency sigifᵢ to the corresponding PS 78 (e.g., without passing signals at other frequencies). This may serve to reduce self-mixing and thermal noise in the intermediate frequency signal. In implementations where radio-frequency signal sigrf is a DSB signal, BPF 76 may also serve to filter out the other sideband 84 from the signal. The example of FIG. 3 is illustrative and, if desired, BPF 70 and/or BPF 76 may be implemented using other types of filters (e.g., low pass filters, high pass filters, notch filters, etc.).

PS 78 may receive the filtered intermediate frequency signal sigifᵢ from BPF 76. PS 78 may be an intermediate frequency (IF) phase shifter that applies a selected phase shift to the received intermediate frequency signal sigifᵢ. PS 78 may pass the phase shifted intermediate frequency signal sigifᵢ to signal combiner 64. PS 78 may receive a control signal (e.g., control signal 52 of FIG. 2) that sets the phase shift imparted by PS 78 and that adjusts the phase shift over time. The phase shifts applied by the phase shifters 78 across receive paths 62 may serve to reverse the phase shifts between each of the antennas 30 in phased antenna array 54 and thus between each of receive paths 62 (e.g., to mitigate or reverse the phase shifts between the radio-frequency signals sigrfᵢ illustrated by curves 90 in plot 88, which is caused by the path length differences traversed by THE signals 34 in reaching each of the antennas 30 in phased antenna array 54). In other words, phase shifters 78 may collectively align the phases of each of the N intermediate frequency signals sigifᵢ received by the N antennas 30 in phased antenna array 54, thereby reversing the incoherence between the N radio-frequency signals prior to passing the phase-shifted intermediate frequency signals sigifᵢ to signal combiner 64. Once phase-aligned by phase shifters 78, the intermediate frequency signals sigifᵢ on each of the N receive paths 62 effectively form a single coherent (phase-aligned) intermediate frequency signal sigif that is received by signal combiner 64.

Signal combiner 64 may combine (add) the N phase-aligned (coherent) intermediate frequency signals sigif received from each receive paths 62 and may transmit the combined (added) intermediate frequency signal to I/Q demodulator 66. This may serve to boost the total power of the wireless data in radio-frequency signal sigrf as received by I/Q demodulator 66 (e.g., may boost the gain of the received signal relative to implementations where only a single antenna 30 receives THF signals 34).

I/Q demodulator 66 may be an intermediate frequency demodulator. I/Q demodulator 66 may perform I/Q demodulation on intermediate frequency signal sigif (e.g., may demodulate intermediate frequency signal sigif) to recover (e.g., decode or demodulate) the wireless data conveyed by radio-frequency signal sigrf from intermediate frequency signal sigif. I/Q demodulator 66 may output the demodulated wireless data as I/Q data at its output 68. An analog-to-digital converter (not shown) may convert the I/Q data from the analog domain to the digital domain. Baseband circuitry may process the digital I/Q data, may pass the digital I/Q data up the protocol stack, and/or may perform any desired operations based on the digital I/Q data. I/Q demodulator 66 may demodulate the wireless data using any desired demodulation scheme (e.g., corresponding to the modulation scheme used by the external communications equipment to modulate the wireless data onto radio-frequency sigrf).

In this way, beamforming for phased antenna array 54 is performed by phase shifters 78 in the intermediate frequency domain rather than in the sub-THz domain. Since electronic phase shifters that operate at sub-THz frequencies are not yet readily available or feasible, this eliminates the need to implement the receiver as an opto-electrical receiver having optical phase shifters for performing beamforming.

In addition, ED 74 may be a passive envelope detector (e.g., ED 74 may include passive circuit components without any active/powered components, the components of ED 74 do not receive any power supply voltages or bias voltages, etc.). As such, ED 74 may operate without consuming additional power in device 10. At the same time, ED 74 may be insensitive to phase noise and frequency drift. This may serve to substantially reduce the phase noise introduced to the received signal as well as the power consumption of device 10 relative to implementations where device 10 receives THF signals 34 using a local oscillator (e.g., in implementations where the receiver is a coherent receiver or an electro-optical receiver). ED 74 may sometimes also be referred to herein as passive ED 74, square law ED 74, or passive square law ED 74. Using envelope detectors 74 and IF phase shifters 78 to receive radio-frequency signal sigrf using phased antenna array 54 may allow device 10 to receive radio-frequency signal sigrf without using a local oscillator, which minimizes phase noise and frequency drift (thereby optimizing the quality of the received wireless data) as well as minimizing power consumption in device 10.

FIG. 4 is a circuit diagram showing one example of circuitry that may be used to implement ED 74. As shown in FIG. 4, ED 74 may be disposed along signal path 28 (e.g., as part of a corresponding receive chain 62 of FIG. 3). Signal path 28 may include a pair of signal lines 92. Signal lines 92 may include a first (positive) signal line 92A and a second (negative or ground) signal line 92B. If desired, signal lines 92A and 92B may form a differential pair of signal lines.

ED 74 may include one or more passive circuit components coupled between signal lines 92A and 92B. For example, ED 74 may include a diode 94, a capacitance 96 (e.g., one or more capacitors), and a load 98 (e.g., one or more resistors) coupled in parallel between signal paths 92A and 92B. Diode 94, capacitance 96, and load 98 may serve to perform square law envelop detection on an input signal received over signal path 28. As diode 94, capacitance 96, and load 98 are passive, unpowered components, ED 74 consumes a minimal amount of power in device 10. The example of FIG. 4 is illustrative and, in general, ED 74 may have other architectures.

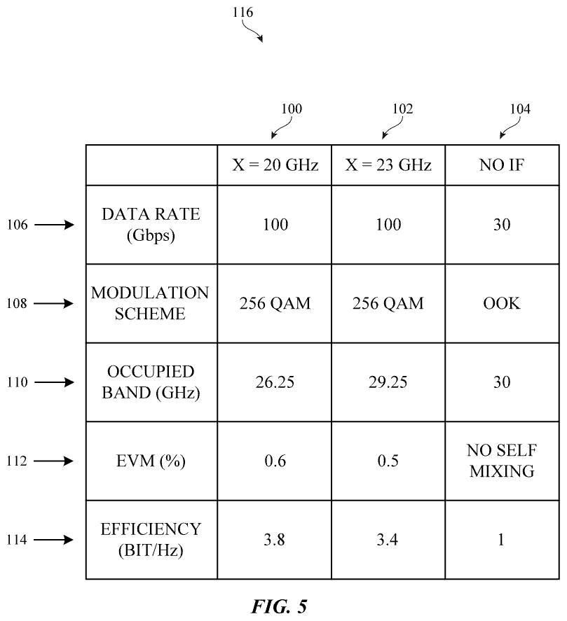

FIG. 5 includes a table 116 showing how non-coherent receiver 60 of FIG. 3 may serve to maximize spectral efficiency for device 10. In the example of FIG. 5, bandwidth BW is equal to 12.5 GHz and the effect of thermal noise is not considered. The entries of table 116 list characteristics of wireless circuitry 24 in receiving radio-frequency signal sigrf. Column 104 of table 116 lists the characteristics when wireless circuitry 24 receives the signal using simple on-off keying (OOK) modulation without envelope detectors 74 and without downconverting to intermediate frequency X. Column 102 of table 116 lists the characteristics when wireless circuitry 24 includes envelope detectors 74 and when intermediate frequency X is 23 GHz. Column 100 of table 116 lists the characteristics when wireless circuitry 24 includes envelope detectors 74 and when intermediate frequency X is 20 GHz.

Row 106 of table 116 plots the supported data rate with which the signal is received. Row 108 lists the corresponding modulation scheme. Row 110 lists the frequency band occupied by the signal. Row 112 lists the error vector magnitude (EVM) of the received signal. Row 114 lists the spectral efficiency (in bits/Hz) with which wireless circuitry 24 receives the signal.

As shown by row 106, non-coherent receiver 60 of FIG. 3 may exhibit significantly higher data rates in receiving the signal relative to the OOK modulation example of column 104. As shown by row 112, while the OOK modulation example of column 104 does not include self-mixing products that deteriorate EVM, the EVM of non-coherent receiver 60 of FIG. 3 is still relatively small. As shown by row 114, non-coherent receiver 60 of FIG. 3 may exhibit significantly higher spectral efficiency in receiving the signal relative to the OOK modulation example of column 104. Table 116 of FIG. 5 includes just a few examples and is illustrative and non-limiting. In addition, non-coherent receiver 60 of FIG. 3 may, for example, allow for a reduction in bandwidth BW by supporting higher modulation orders (e.g., 256 QAM or higher orders). This may serve to reduce beam squint effects by phased antenna array 54 (e.g., to negligible levels).

As used herein, the term “concurrent” means at least partially overlapping in time. In other words, first and second events are referred to herein as being “concurrent” with each other if at least some of the first event occurs at the same time as at least some of the second event (e.g., if at least some of the first event occurs during, while, or when at least some of the second event occurs). First and second events can be concurrent if the first and second events are simultaneous (e.g., if the entire duration of the first event overlaps the entire duration of the second event in time) but can also be concurrent if the first and second events are non-simultaneous (e.g., if the first event starts before or after the start of the second event, if the first event ends before or after the end of the second event, or if the first and second events are partially non-overlapping in time). As used herein, the term “while” is synonymous with “concurrent.”

Device 10 may gather and/or use personally identifiable information. It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The methods and operations described above in connection with FIGS. 1-13 may be performed by the components of device 10 using software, firmware, and/or hardware (e.g., dedicated circuitry or hardware). Software code for performing these operations may be stored on non-transitory computer readable storage media (e.g., tangible computer readable storage media) stored on one or more of the components of device 10 (e.g., storage circuitry 16 of FIG. 1). The software code may sometimes be referred to as software, data, instructions, program instructions, or code. The non-transitory computer readable storage media may include drives, non-volatile memory such as non-volatile random-access memory (NVRAM), removable flash drives or other removable media, other types of random-access memory, etc. Software stored on the non-transitory computer readable storage media may be executed by processing circuitry on one or more of the components of device 10 (e.g., processing circuitry 18 of FIG. 1, etc.). The processing circuitry may include microprocessors, central processing units (CPUs), application-specific integrated circuits with processing circuitry, or other processing circuitry.

The foregoing is merely illustrative and various modifications can be made to the described embodiments. The foregoing embodiments may be implemented individually or in any combination.

What is claimed is:

1. An electronic device comprising:
a demodulator;
a phased antenna array configured to receive a radio-frequency signal at a first frequency greater than or equal to 100 GHz, the phased antenna array including a first antenna communicatively coupled to the demodulator over a first receive path;
a first envelope detector disposed on the first receive path and configured to downconvert the radio-frequency signal to a second frequency; and
a first phase shifter disposed on the first receive path between the first envelope detector and the demodulator, the first phase shifter being configured to phase shift the radio-frequency signal downconverted by the first envelope detector.

2. The electronic device of claim 1, wherein the phased antenna array includes a second antenna that is coupled to the demodulator over a second receive path, the electronic device further comprising:
a second envelope detector disposed on the second receive path and configured to downconvert the radio-frequency signal to the second frequency.

3. The electronic device of claim 2, further comprising:
a second phase shifter disposed on the second receive path between the second envelope detector and the demodulator, the second phase shifter being configured to phase shift the radio-frequency signal downconverted by the second envelope detector.

4. The electronic device of claim 3, further comprising:
a signal combiner that couples the first receive path and the second receive path to an input of the demodulator.

5. The electronic device of claim 1, wherein the first envelope detector comprises a square law envelope detector.

6. The electronic device of claim 1, wherein the first envelope detector is passive.

7. The electronic device of claim 1, wherein the radio-frequency signal comprises a carrier at the first frequency and a sideband that carries wireless data, the demodulator being configured to recover the wireless data from the sideband.

8. The electronic device of claim 7, wherein the first envelope detector is configured to output an intermediate frequency signal at the second frequency and the first phase shifter is configured to phase shift the intermediate frequency signal.

9. The electronic device of claim 1, further comprising:
a first bandpass filter disposed on the first receive path between the first antenna and the first envelope detector;
a low noise amplifier disposed on the first receive path between the first bandpass filter and the first envelope detector; and
a second bandpass filter disposed on the first receive path between the first envelope detector and the first phase shifter.

10. The electronic device of claim 1, wherein the first signal path includes a first signal line and a second signal line, the first envelope detector comprising a diode, a capacitance, and a load coupled in parallel between the first signal line and the second signal line.

11. Wireless circuitry comprising:
a first receive path configured to receive a radio-frequency signal having a first phase;
a second receive path configured to receive the radio-frequency signal with a second phase that is different from the first phase;
a first envelope detector disposed on the first receive path and configured to generate a first intermediate frequency signal based on the radio-frequency signal having the first phase;
a second envelope detector disposed on the second receive path and configured to generate a second intermediate frequency signal based on the radio-frequency signal with the second phase;
a first phase shifter disposed on the first receive path and configured to apply a first phase shift to the first intermediate frequency signal;
a second phase shifter disposed on the second receive path and configured to apply a second phase shift to the second intermediate frequency signal, the second phase shift being different from the first phase shift; and
a demodulator configured to receive a phase-aligned intermediate frequency signal from at least the first receive path and the second receive path, the demodulator being configured to recover wireless data from the phase-aligned intermediate frequency signal.

12. The wireless circuitry of claim 11, wherein the radio-frequency signal has a carrier frequency greater than or equal to 100 GHz.

13. The wireless circuitry of claim 11, wherein the first envelope detector and the second envelope detector are passive.

14. The wireless circuitry of claim 13, wherein the first envelope detector comprises a first square law envelope detector and the second envelope detector comprises a second square law envelope detector.

15. The wireless circuitry of claim 11, further comprising:
a signal combiner having a first input coupled to the first receive path, a second input coupled to the second receive path, and an output coupled to an input of the demodulator.

16. The wireless circuitry of claim 15, wherein the first phase shift and the second phase shift are configured to align a phase of the first intermediate frequency signal to a phase of the second intermediate frequency signal and the signal combiner is configured to output the phase-aligned intermediate frequency signal by combining the first intermediate frequency signal with at least the second intermediate frequency signal.

17. The wireless circuitry of claim 11, further comprising:
a first bandpass filter disposed on the first receive path;
a first low noise amplifier (LNA) disposed on the first receive path between the first bandpass filter and the first envelope detector;
a second bandpass filter disposed on the first receive path between the first envelope detector and the first phase shifter;
a third bandpass filter disposed on the second receive path;
a second LNA disposed on the second receive path between the third bandpass filter and the second envelope detector; and
a fourth bandpass filter disposed on the second receive path between the second envelope detector and the second phase shifter.

18. An electronic device comprising:
a phased antenna array configured to receive a radio-frequency signal, the radio-frequency signal having a carrier at a first frequency and having a sideband that carries wireless data, the sideband being offset from the carrier by a second frequency; and
a non-coherent receiver coupled to the phased antenna array, the non-coherent receiver including
envelope detectors coupled to respective antennas in the phased antenna array and configured to generate intermediate frequency signals at the second frequency based on the radio-frequency signal,
phase shifters configured to generate a phase-aligned signal at the second frequency based on a set of phase shifts applied to the intermediate frequency signals, and
a demodulator configured to output the wireless data based on the phase-aligned signal.

19. The electronic device of claim 18, wherein the envelope detectors comprise passive square law envelope detectors.

20. The electronic device of claim 19, wherein the demodulator comprises an in-phase quadrature-phase (I/Q) demodulator.
